(19) United States
(12) Patent Application Publication
(10) Pub. No.: US 2008/0027834 A1
(43) Pub. Date: Jan. 31, 2008

(54) Systems and methods for inventory management

(75) Inventors: Douglas Clifford Meyer, Morton, IL (US); Joel Philip Campbell, Morton, IL (US); Darrel Wayne Haynes, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/495,567

(22) Filed: Jul. 31, 2006

(51) Int. Cl. G06Q 10/00

(52) U.S. Cl. 705/28

(57) ABSTRACT

Methods and systems for inventory management are disclosed. In one embodiment, an inventory manager may use an inventory management system to select an inventory management performance metric. The inventory manager may associate a performance metric with a plurality of performance categories. The performance categories indicate a plurality of measurement ranges of the performance metric. The inventory manager may receive inventory management data indicating performance of a business organization measured according to the performance metric. The inventory manager may use the inventory management system to determine a performance category for the business organization based on the inventory management data, and to provide a remedial action plan to the business organization in response to the determination of the performance category.

### TECHNICAL FIELD

This disclosure relates to systems and methods for inventory management. More particularly, this disclosure relates to systems for monitoring performance metrics for a network of warehouses.

### BACKGROUND

Warehouses are used by manufacturers, importers, exporters, wholesalers, transport businesses, customs, and the like, to store and transfer inventories. Inventory refers to any quantifiable item that one can handle, buy, sell, store, consume, produce, or track. Inventory includes, for example, office and maintenance supplies, raw materials used for manufacturing, semi-finished and finished goods, and fuel used to power equipment used in a business. Inventory management refers to the management activities with the purpose of getting the right inventory in the right place at the right time in the right quantity in the right form at the right cost.

An important part of inventory management is warehouse management. Warehouse management systems are often used to provide intelligent warehouse operation directives, automatic inventory consolidation and storage space management to maximize the use of valuable warehouse space. Warehouse managers use warehouse management systems to improve the efficiency and performance of warehouses by maintaining accurate inventory and records of warehouse transactions.

Establishing performance metrics and monitoring warehouse performance metrics are also important aspects of inventory management. Performance metrics measurements track key performance indicators of a warehouse's operations. Performance metrics refer to a system of quantitative and periodic measurement/assessment of a process, including the procedures to carry out such measurement. Performance metrics may also refer to the procedures for interpreting these measurements in light of previous or comparable assessments. Performance metrics measurements can be used to track trends, productivity, resource utilization and the like.

Systems and methods have been developed to determine metrics relevant to a business process of a business enterprise. For example, U.S. Patent Publication No. 2005/0065941 by DeAngelis et al. describes an intelligence analytics engine for determining a metric relevant to a business process of an enterprise and a related data structure in communication with the intelligence analytics engine. The DeAngelis system includes an output device in communication with the intelligence analytics engine for displaying the metric relevant to the business process of an enterprise. The DeAngelis system also includes a process management engine for executing and monitoring the business process of the enterprise and a data structure in communication with the process management engine. The data structure may be for retrieving data from the data sources as needed by the process management engine.

While conventional methods, such as the one disclosed by DeAngelis et al., may be effective for determining metrics for business enterprises, they do not provide mechanisms to consistently manage inventories across a group of business enterprises, such as a network of warehouses. Further, conventional methods do not consistently monitor and evaluate multiple warehouses and provide remedial action plans based on a warehouse's performance. Methods and systems consistent with certain disclosed embodiments address one or more of these problems.

### SUMMARY OF THE INVENTION

It is to be understood that both the foregoing general description and the following detailed description are exemplary and explanatory only and are not restrictive of the invention as claimed.

Methods and systems for inventory management are disclosed. In one embodiment, an inventory manager may use an inventory management system to select an inventory management performance metric. The inventory manager may associate a performance metric with a plurality of performance categories. The performance categories indicate a plurality of measurement ranges of the performance metric. The inventory manager may receive inventory management data indicating performance of a business organization measured according to the performance metric. The inventory manager may use the inventory management system to determine a performance category for the business organization based on the inventory management data, and to provide a remedial action plan to the business organization in response to the determination of the performance category.

### BRIEF DESCRIPTION OF THE DRAWINGS

The accompanying drawings, which are incorporated in and constitute a part of this specification, illustrate exemplary embodiments of the invention and together with the description, serve to explain the principles of the invention. In the drawings:

FIG. 1 is a block diagram of an inventory management environment consistent with certain disclosed embodiments;

FIG. 2 is a block diagram of an inventory management architecture consistent with certain disclosed embodiments;

FIG. 3A is a flow chart illustrating an exemplary process to define performance metrics consistent with certain disclosed embodiments;

FIG. 3B is a diagram illustrating an exemplary performance goal associated with performance categories consistent with certain disclosed embodiments;

FIG. 3C is a diagram illustrating another exemplary performance goal associated with performance categories consistent with certain disclosed embodiments;

FIG. 3D is a diagram illustrating three remedial action plans associated with performance categories consistent with certain disclosed embodiments; and

FIG. 4 is a flow chart illustrating an exemplary process to monitor performance metrics and recommend remedial action plans consistent with certain disclosed embodiments.

### DETAILED DESCRIPTION

Reference will now be made in detail to the disclosed embodiments, examples of which are illustrated in the accompanying drawings. Wherever possible, the same reference numbers will be used throughout the drawings to refer to the same or like parts.

Methods and systems consistent with the disclosed embodiments may relate to an inventory management system for managing a group of business organizations. A business organization may be any entity that is configured to perform business. For example, a warehouse facility with warehouse management personnel may be referred to as a business organization. A business organization may also be an entity that manages a network of entities. A business organization may have divisional and/or sub-organizations. It should be noted that the disclosed embodiments are not limited to any particular type of business entity.

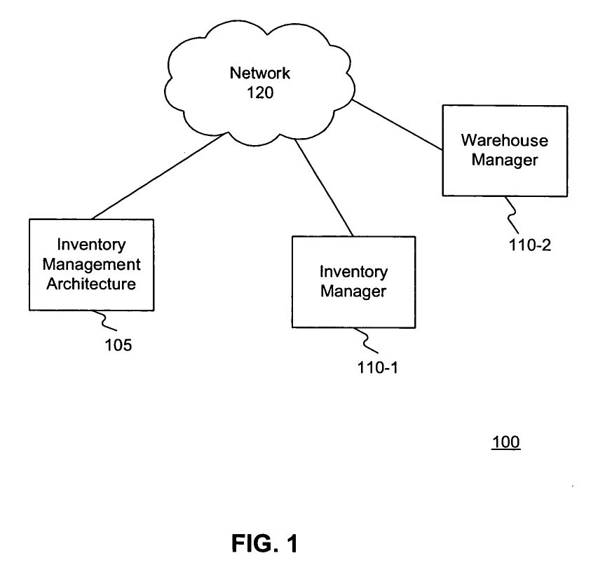

FIG. 1 illustrates a block diagram of an inventory management environment 100 consistent with certain embodiments of the present disclosure. As shown in FIG. 1, inventory management environment 100 may include an inventory management architecture 105, an inventory manager 110-1, a warehouse manager 110-2 and a network 120.

Inventory management architecture 105 may be a computer system including hardware/software that enables collaboration among members 110 of inventory management environment 100, such as inventory manager 110-1 and warehouse manager 110-2. A member may be any individual, software application, and/or system that uses the features of inventory management environment 100. Inventory management architecture 105 may generate, maintain, update, delete, and present inventory data records and inventory data change entries. An inventory data record may include any data related to inventory management used by inventory management architecture 105.

Inventory manager 110-1 and warehouse manager 110-2 may each reflect one or more individuals who perform corresponding inventory management functions in inventory management environment 100. Inventory manager 110-1 and warehouse manager 110-2 may each represent one or more computer systems, and/or software applications executed by a processor; configured to perform corresponding functions related to inventory management environment 100. These computer systems may each include a memory, a processor, and a display for presenting one or more maps, graphs, messages, and the like, consistent with certain disclosed embodiments of inventory management architecture 105.

Inventory manager 110-1 may be an individual who manages inventory for one or more business organizations. For example, inventory manager 110-1 may be responsible for managing inventory across a network of warehouses. Inventory manager 110-1 may collect inventory management data related to inventory management activities, such as inventory accuracy data from warehouses. Inventory management data may include, for example, one or more type of data reflecting the acquisition, transportation, storage, consumption, loss, and sales of inventories. Inventory management data may also include audit data and/or statistic estimates used to manage inventory accuracy. Inventory accuracy may be measured as accountability of inventory based on the quantity of inventory or the value of inventory. Inventory accuracy may also be measured by location accuracy. Location accuracy refers to the accountability of inventory in a defined area of a warehouse. In one embodiment, inventory manager 110-1 may be computer software or a computer system operated by a user that performs the features described herein.

Inventory manager 110-1 may define performance goals for the one or more business organizations based on the inventory management data. A performance goal may be any type of performance objective to be achieved by a business organization. Performance metrics refer to a system of quantitative and periodic measurement/assessment of a process, including the procedures to carry out such measurement. A performance goal is measured in reference to its corresponding performance metric. As such, in this disclosure, a performance goal and a performance metric may be used interchangeably.

Inventory manager 110-1 may also define remedial action plans for a business organization when it fails to meet its performance goals. For example, inventory manager 110-1 may determine that a performance goal for warehouse A is to reach 99% accountability of all inventory items stored in its facility. Inventory manager 110-1 may also define and recommend a remedial action plan for warehouse A if it fails to reach the 99% accountability performance goal. A remedial action plan may include one or more action items that can be implemented to improve a business organization's performance. A remedial action plan may be any type of plan that outlines specific actions or programs aimed to improve performance of a business organization, such as a warehouse, or a network of warehouses.

Inventory manager 110-1 may receive input (e.g., comments, data, etc.) regarding performance goals and/or remedial action plans through inventory architecture 105. For example, inventory manager 110-1 may incorporate comments and feedback from a customer or one or more business organizations by modifying performance goals and/or remedial action plans. Referring to the above example of warehouse A, inventory manager 110-1 may receive comments from a manager of warehouse A regarding the 99% accountability of inventory items performance goal. For example, the 99% accountability performance goal may be too high or too low for warehouse A. Inventory manager 1101-1 may adjust the performance goal of 99% accountability based on the received feedback.

Inventory manager 110-1 may store data related to inventory management, performance goals, inputs and comments received from business organizations in inventory management architecture 105. Although only one inventory manager 110-1 is illustrated in FIG. 1, inventory management environment 100 may include a plurality of software programs or persons who collectively or individually perform similar tasks.

Warehouse manager 110-2 may be an individual who manages one or more business organizations, such as one or more warehouse facilities among the network of warehouses managed by inventory manager 110-1. Warehouse manager 110-2 may collect inventory management data, such as inventory accuracy data from the one or more warehouses. Warehouse manager 110-2 may conduct audits of inventories in the one or more warehouses, and collect audit data. Warehouse manager 110-2 may store the collected data in inventory management architecture 105.

Warehouse manager 110-2 may review performance goals defined by inventory manager 110-1. Warehouse manager 110-2 may review remedial action plans for the one or more warehouses. Warehouse manager 110-2 may implement the remedial action plans presented by inventory management architecture 105 in the one or more warehouse facilities. Warehouse manager 110-2 may submit comments and feedback regarding the performance goals and the remedial action plans for the one or more warehouses. Warehouse manager 110-2 may store comments and feedback from the one or more warehouses in inventory management architecture 105. Although only one warehouse manager is illustrated in FIG. 1, inventory management environment 100 may include a plurality of software programs or persons who collectively or individually perform similar tasks.

Each component of inventory management environment 100 may exchange data via network 120. Network 120 may be the Internet, a wireless local area network (LAN), or any other type of network. Thus, network 120 may be any type of communications system. Each member of inventory management environment 100 may provide inquiries or respond to inquiries using network 120.

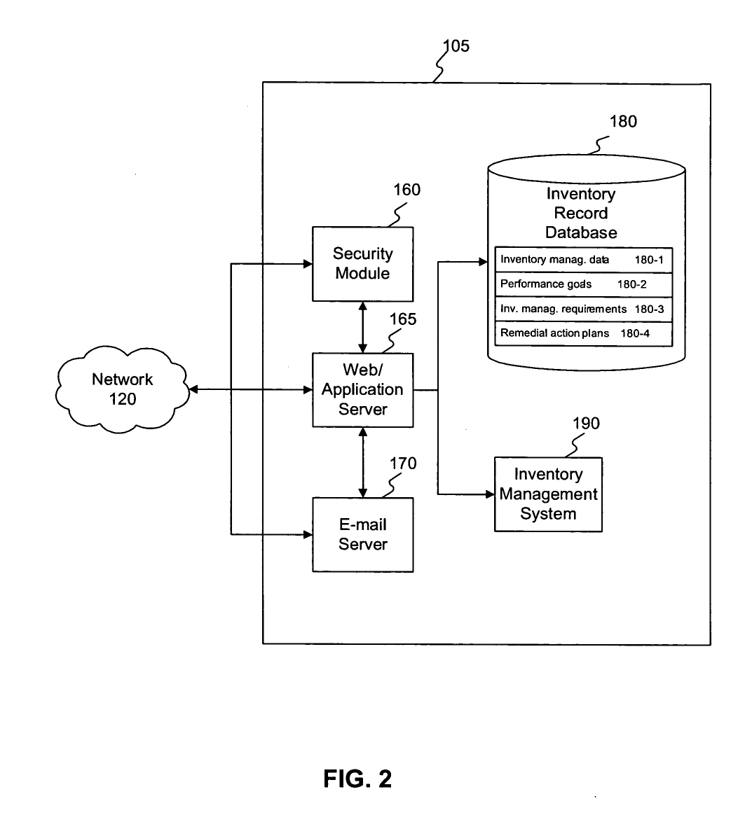

FIG. 2 is a block diagram illustrating an inventory management architecture 105 consistent with certain disclosed embodiments. Inventory management architecture 105 may include a security module 160, a Web/application server 165, an e-mail server 170, an inventory record database 180, and an inventory management system 190. Security module 160, Web/application server 165, and e-mail server 170 interface with network 120. Web/application server 165 may also be connected to security module 160, e-mail server 170, inventory record database 180, and inventory management system 190. It is contemplated that an inventory management architecture 105 may include additional or fewer components than those shown in FIG. 2.

Security module 160 may be a computer system or software executed by a processor that is configured to determine the type of access each member in inventory management environment 100 is authorized with respect to inventory record database 180 and/or inventory management system 190. For example, security module 160 may determine that warehouse manager 110-2 may be authorized to access data records in inventory record database 180 but may not be authorized to modify the records related to warehouses managed by other members of inventory management environment 100. Inventory manager 110-1, on the other hand, may be permitted to access and modify all data records stored in inventory record database 180. Further, security module 160 may be used to assign and verify different levels of access for different members, based on, for example, a member's role in inventory management environment 100. For example, warehouse manager 110-2 may be permitted access to only a portion of inventory record database 180 related to the one or more warehouse facilities associated with warehouse manager 110-2. Inventory manager 110-1, however, may be allowed to access the entire inventory record database 180.

Web/application server 165 may include an interface that allows members 110 to access and edit inventory record database 180, and/or inventory management system 190. Further, web/application server 165 may generate a notification, such as an email, that is sent to one or more members 110 of inventory management environment 100. The notification may indicate that the inventory management architecture 105 has completed an operation or a record has been received. The notification may also indicate that the operation or record is available for review.

Web/application server 165 may also include additional components, such as software communication tools that permit collaboration of members of inventory management environment 100, bulletin boards to permit individuals of inventory management environment 100 to communicate with each other, and/or search engines to provide efficient access to specific entries in inventory record database 180 or inventory management system 190. In one embodiment, web/application server 165 may be Apache HTTP Server from the Apache Software Foundation, IBM WebSphere, or any other web/application server known in the art.

E-mail server 170 may be a computer system or software executed by a processor that is configured to provide e-mail services for members 110 of inventory management environment 100. The e-mail services may provide messages including current information from inventory management architecture 105. For example, when a warehouse fails to meet its performance goals, inventory manager 110-1 may use e-mail server 170 to send messages to members 110 of inventory management environment 100.

Inventory record database 180 may be a database computer system and/or software executed by a processor that is configured to store data records, entries for changes made to the data records, and other information used by individuals in inventory management environment 100. Inventory management architecture 105 may include one or more inventory record databases 180.

In one embodiment, inventory record database 180 may store inventory management data records 180-1. An inventory management data record 180-1 may include inventory information tracking the acquisition, storage, transportation, sales, or consumption of certain inventory items. An inventory management data record 180-1 may also include audit data and/or statistic estimates used to manage inventory.

Inventory record database 180 may also store performance goals 180-2 defined by inventory manager 110-1. A performance goal may be specific to a single business organization, such as one warehouse. Alternatively, a performance goal may be applicable to multiple business organizations managed in inventory management environment 100. A performance goal 180-2 may be associated with one or more performance categories. A performance category may indicate the level of success of a business organization in achieving a performance goal. For example, a performance goal 180-2 may be inventory accuracy measured by a specific audit result. Inventory manager 110-1 may define corresponding performance categories as “red,” “yellow,” and “green” for different performance levels. For example, inventory manager 110-1 may associate a warehouse with inventory accuracy equal to or more than 99% with the “green” category. Inventory manager 110-1 may associate a warehouse with inventory accuracy between 95%-99% with the “yellow” category. And, inventory manager 110-1 may associate a warehouse with inventory accuracy of less than 95% with the “red” category.

Inventory records database 180 may store inventory management requirement 180-3. An inventory management requirement 180-3 may refer to any business or operational requirement submitted by a member of inventory management environment 100 to define what a business organization, such as a warehouse, should deliver or accomplish regarding inventory management. For example, an inventory management requirement 180-3 may be that each warehouse should maintain an inventory accuracy of 95% when measured by a specific audit result.

Inventory record database 180 may also store remedial action plans 180-4 associated with performance categories defined by inventory manager 110-1. A remedial action plan 180-4 may include one or more action items. A remedial action plan 180-4 may be specific to a single business organization, such as one warehouse. Alternatively, a remedial action plan 180-4 may be applicable to multiple business organizations managed by inventory management environment 100. A remedial action plan 180-4 may also correspond to one or more performance categories. Referring to the above example of color coded performance categories for inventory accuracy, inventory records database 180 may store a remedial action plan “A—inventory accuracy yellow” corresponding to performance category “yellow.” Remedial action plan A may include one or more action items.

Inventory management system 190 may be a computer system or software executed by a processor that is configured to provide access to records stored in a number of different formats, such as word processing format, spread sheet format, presentation format, and the like. Inventory management system 190 may facilitate capture of inventory management data records and changes, by hosting a management process that facilitates the activities of members 110 of inventory management environment 100. Inventory management system 190 may enable members 110 of inventory management environment 100 to define inventory management data 180-1, performance goals 180-2, inventory management requirement 180-3, and remedial action plans 180-4, and the like.

In one embodiment, inventory management system 190 may enable inventory manager 110-1 and warehouse manager 110-2 to submit and store inventory management data 180-1 into inventory record database 180. Inventory management system 190 may allow inventory manager 110-1 to define performance goals 180-2 and remedial action plans 180-3. Inventory management system 190 may allow warehouse manager 110-2 to enter data, such as inventory management data 180-1, into inventory records database 180. Inventory manager 110-1 may use inventory management system 190 to monitor the performance of business organizations, such as a network of warehouses. When a warehouse managed by warehouse manager 110-2 fails to meet one of its performance goals 180-2 measured by performance categories, inventory manager 110-1 may notify warehouse manager 110-2 through inventory management system 190. Inventory manager 110-1 may use inventory management system 190 to present warehouse manager 110-2 with a recommended remedial action plan 180-4 that aims to improve the performance of the warehouse. Warehouse manager 110-2 may implement the proposed remedial action plan 180-4.

Referring back to the above color coded performance category example, inventory management system 190 may monitor inventory accuracy for a network of warehouses and notify members 110 of inventory management environment 100 when a warehouse's inventory accuracy is below the range defined by the “green” category, and into the range defined by the “yellow” category. Inventory manager 110-1 may use inventory management system 190 to present the remedial action plan “A—inventory accuracy yellow,” corresponding to the “yellow” performance category, to warehouse manager 110-2. Warehouse manager 110-2 would be responsible for implementing action items according to remedial action plan “A—inventory accuracy yellow” for the warehouse.

Warehouse manager 110-2 may also use inventory management system 190 to submit feedback or comments regarding performance goals 180-2 and remedial action plans 180-4. Inventory manager 110-1 may use inventory management system 190 to incorporate the feedback or comments by modifying performance goals 180-2 and/or the remedial action plans 180-4.

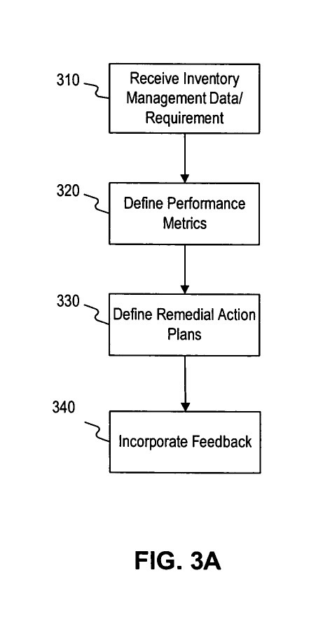

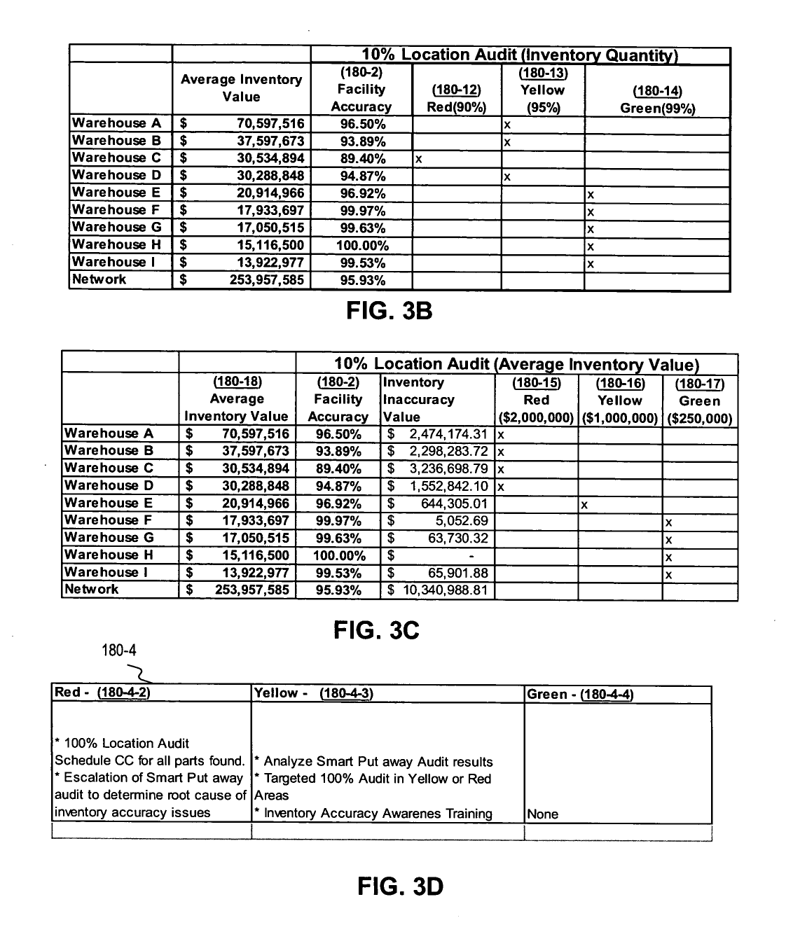

FIG. 3A is a flow chart of an exemplary process of collecting inventory management data 180-1, defining performance goals 180-2, receiving inventory management requirements 180-3, and defining remedial action plans 180-4 consistent with certain disclosed embodiments. First, inventory manager 110-1 may use inventory management system 190 to collect inventory management data 180-1 and/or inventory management requirements 180-3 (step 310).

Inventory manager 110-1 may receive inventory management data records 180-1 from warehouse manager 110-2. Inventory management data records 1801-1 may provide inventory tracking information in one or more of the warehouses managed by inventory manager 110-1. For example, warehouse manager 110-2 may submit an inventory management data record 180-1 to inventory management system 190. The inventory management data record 180-1 may indicate that warehouse A had an overall inventory accuracy of 96.5% based on the 10% location audit conducted in January, 2005. A 10% location audit refers to a location accuracy audit which estimates the overall inventory accuracy of a warehouse based on location verification conducted in 10% of the warehouse's areas. An inventory accuracy audit may be any periodic verification of inventory accuracy by using a sampling of inventory data and physical counts to determine inventory correctness. Inventory accuracy may be measured based on, for example, quantity of inventory or average/total value (dollar amount) of inventory.

Inventory management requirement 180-3 may be any data describing one or more inventory management goals that may be achieved by one or more business organizations. For example, inventory management requirement 180-3 may reflect that a warehouse needs to achieve 95% location accuracy when measured by the 10% location audit. Inventory manager 110-1 may create an inventory management requirement 180-3 using inventory management system 190. Alternatively, inventory manager 110-1 may receive an inventory management requirement 180-3 through inventory management system 190 from members of inventory management environment 100.

In one embodiment, a warehouse management entity, such as the warehouse owner, for warehouse A may submit to inventory manager 110-1 an inventory management requirement 180-3. The inventory management requirement 180-3 may require warehouse A to meet certain operational performance goals. For example, the warehouse management entity may require that warehouse A maintain a 99% inventory accuracy based on average inventory value in any given month. Because inventories move in and out of warehouses constantly, average inventory value is often used when measuring performance of a warehouse. An average inventory value may refer to the average value of inventory in a given warehouse over a defined period of time, such as the monthly average inventory value over the twelve months of 2005 for warehouse A

Next, inventory manager 110-1 may define performance measures and goals 180-2 based on inventory management data 180-1 and inventory management requirements 180-3 (step 320). Inventory manager 110-1 may also consider other related information when defining performance goals 180-2. FIG. 3B illustrates a performance goal 180-2 of overall facility inventory accuracy and the associated performance categories consistent with certain disclosed embodiments. Overall facility inventory accuracy may be measured based on quantity of inventory or average inventory value. Inventory manager 110-1 may define that the overall facility accuracy is measured by the overall location accuracy determined based on the 10% location audit of a warehouse. Inventory manager 110-1 may define that, based on the location accuracy, a warehouse with an overall location accuracy 180-2 lower than 90% would be in the “red” performance category 180-12, a warehouse with an overall location accuracy between 90% and 95% would be in the “yellow” performance category 180-13, and a warehouse with an overall location accuracy higher than 99% would be in the “green” performance category 180-14.

FIG. 3C illustrates another performance goal 180-2 of overall facility inventory accuracy and the associated performance categories consistent with certain disclosed embodiments. Inventory manager 110-1 may define performance categories 180-15, 180-16, and 180-17 based on a warehouse's average inventory value of past twelve months. Inventory manager 110-1 may decide to monitor a warehouse with highly valued inventories more closely than another warehouse with less valuable inventories. As a result, inventory manager 110-1 may define performance categories 180-15, 180-16, and 180-17 based on average inventory value 180-18 and overall facility accuracy 180-2. Inventory manager 110-1 may determine that a warehouse with an average value inventory inaccuracy of over $2,000,000 falls into the “red” performance category 180-15; a warehouse with an average value inventory inaccuracy of $250,000-$2,000,000 falls into the “yellow” performance category 180-16; and a warehouse with an average value inventory inaccuracy below $250,000 falls into the “green” performance category 180-17.

In FIG. 3B, warehouse A has an overall facility accuracy of 96.5% based on quantity of inventory. As shown in FIG. 3C, the average inventory value 180-18 for warehouse A over the past twelve months may be $70,597,516. According to the overall facility accuracy 180-2 and average inventory value 180-18, warehouse A has an unaccounted inventory with an average value of $2,474,174 (3.5%×$70,597,516). Thus, warehouse A has an average value of $2,474,174 (3.5%×$70,597,516) of inventory inaccuracy, and, therefore, is defined in the “red” performance category 180-15.

Because of its relatively high average inventory value 180-18, warehouse A falls into the “red” performance category when measured by average inventory value (in FIG. 3C) instead of the “yellow” performance category when measured by inventory quantity (in FIG. 3B). Accordingly, inventory manager 110-1 and warehouse manager 110-2 may adjust how it manages a warehouse to improve its performance based on the type of measurement.

Inventory manager 110-1 may define performance goals and categories based on operation accuracy and efficiency of a specific warehouse operation. Such performance goals and categories may be based on audit results on put away, picking, shipping, and other warehouse operations. Inventory manager 110-1 may also define performance goals and categories based on equipment or labor related costs. Such categories may be based on savings on equipment maintenance cost, reduced human accidents, and the like. Inventory manager 110-1 may also define performance goals and categories based on customer service quality. The categories may be based on increased customer orders, on-time shipping, and the like. It is contemplated that inventory manager 110-1 may define many performance goals and categories in inventory management system 190.

Next, inventory manager 110-1 may define a remedial action plan 180-4 corresponding to a performance category 180-12, 180-13, or 180-14 (step 330). FIG. 3D illustrates a set of remedial action plans 180-4 defined corresponding to a warehouse's overall facility inventory accuracy performance categories as shown in FIG. 3B. Referring back to the example of FIG. 3B, inventory manager 110-1 may define remedial action plans 180-4-2, 180-4-3 and 180-4-4 (FIG. 3D) corresponding to the performance categories 180-12, 180-13 and 180-14 (FIG. 3B). For example, inventory manager 110-1 may decide that no remedial action is needed if a warehouse's overall facility accuracy is in the “green” category 180-14. Inventory manager 110-1 may recommend a remedial action plan 180-4-3 for a warehouse that has an overall facility inventory accuracy in the “yellow” performance category 180-13. Remedial action plan 180-4-3 may provide recommended remedial action items for warehouse manager 110-2 to improve the performance of the warehouse. Inventory manager 110-1 may recommend a remedial action plan 180-4-2 for a warehouse that has an overall facility inventory accuracy in the “red” performance category 180-12.

As shown in FIG. 3D, in one embodiment, when a warehouse's overall facility accuracy falls in the “yellow” performance category 180-13 (FIG. 3B-overall facility inventory accuracy between 90% and 95%) inventory manager 110-1 may recommend that warehouse manager 110-2 implement remedial action plan 180-4-3. Accordingly, warehouse manager 110-2 may analyze the warehouse's put away audit results (180-4-3). Put away audits may be any type of audit conducted to verify the accuracy and/or efficiency of a warehouse's put away operations. Put away operations refer to processes of receiving and storing goods in a storage area. A warehouse's put away accuracy may impact its overall facility inventory accuracy 180-2. Improved put away accuracy may improve the overall facility inventory accuracy 180-2. As such, inventory manager 110-1 may recommend that warehouse manager 110-2 analyze his warehouse's put away audit results to improve the warehouse's put away operation accuracy. Similarly, inventory manager 110-1 may recommend inventory accuracy awareness training for the warehouse staff (180-4-3). Such training would improve the awareness and skills of the warehouse staff, and therefore also improve the warehouse's performance in overall facility inventory accuracy 180-2. Inventory manager 110-1 may define remedial action items of remedial action plans 180-4 based on past experience, past warehouse performance data, budge restraint, statistic modeling, and/or other business/operations factors. Warehouse manager 110-2 may be required to implement remedial action plans 180-4-3. Alternatively, warehouse manager 110-2 may determine which remedial action items of remedial action plan 180-4-3 to implement based on budget and other operational concerns.

Inventory manager 110-1 may recommend remedial action plan 180-4-2 when a warehouse's overall facility inventory accuracy falls in the “red” category 180-12 (inventory accuracy below 90%). Inventory manager 110-1 may suggest that warehouse manager 110-2 conduct a 100% location audit and to create a detailed list for all parts found through the audit. 100% location audit may refer to any type of audit process that verifies inventory accountability which is conducted through all areas (100%) of a warehouse. When a warehouse has an overall facility inventory accuracy of less than 90%, conducting a 100% location audit may help locating missing inventory items and identify problematic areas with low inventory accuracy. Further, warehouse manager 110-2 may be required to implement remedial action plan 180-4-2. For example, if a warehouse's performance falls in “red” performance category 180-12, implementing action items in remedial action plan 180-4-2 may be mandatory as set forth by the business entities managing operations of the warehouse. Alternatively, warehouse manager 110-2 may determine which remedial action items to implement based on budget and other operational concerns.

In the process of setting performance goals 180-2 and remedial action plans 180-4, inventory manager 110-1 may receive comments from warehouse manager 110-2 and other members 110 of inventory management environment 100 (step 340). Inventory manager 110-1 may incorporate the received comments by modifying performance goals and performance categories. For example, inventory manager 110-1 may modify performance goals 180-2 and remedial action plans 180-4 according to the received comments and feedback. Inventory manager 110-1 may also create inventory management requirement 180-3 in based on the comments/feedback.

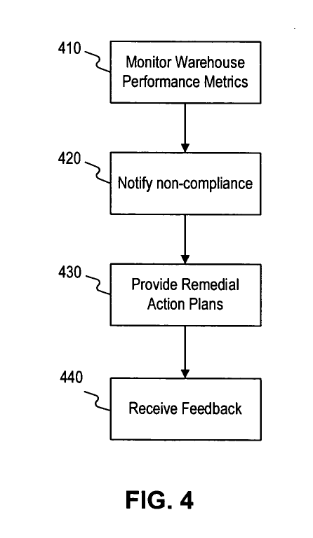

Once inventory manager 110-1 has defined performance goals 180-2 and remedial action plans 180-4, inventory manager 110-1 may manage the network of warehouses using inventory management system 190. FIG. 4 illustrates a flow chart of an exemplary process for managing a warehouse within the network of warehouses consistent with certain disclosed embodiments.

First, both inventory manager 110-1 and warehouse manager 110-2 may monitor a warehouse, such as warehouse B by checking its performance metrics (step 410). For example, warehouse manager 110-2 may be responsible for managing warehouse B. Warehouse manager 110-2 may conduct a 10% location audit to determine that the overall facility accuracy based on location accuracy is 93.89% for warehouse B. As shown in FIG. 3B, warehouse manager 110-2 may enter the overall location accuracy 180-2 of 93.89% in inventory management system 190.

Inventory management system 190 may notify warehouse manager 110-2 when a warehouse's metric measurement is not meeting performance goals (step 420). Referring back to the example of warehouse B, in one embodiment, inventor manager 110-1 may define the performance goal 180-2 as shown in FIG. 3B. Inventory management system 190 may send a notification to warehouse manager 110-2 when warehouse B's location accuracy falls below 95% (equal to or below the “yellow” performance category threshold). As shown in FIG. 3B, warehouse B, with a location accuracy of 93.86% would fall into the “yellow” performance category 180-13. Thus, inventory management system 190 may send a notification to warehouse manager 110-2, alerting the non-compliance.

Based on a warehouse's performance category, inventory management system 190 may accordingly provide remedial action plans (step 430). Referring back to the example of warehouse B, as shown in FIGS. 3B and 3D, in one embodiment, inventory management system 190 may monitor warehouse B's performance metrics. When warehouse B's inventory accuracy falls into the “yellow” performance category 180-13 (FIG. 3B), inventory management system 190 may automatically send remedial action plan 180-4-3 (FIG. 3D) to warehouse manager 110-2. Warehouse manager 110-2 may review the suggested action items in 180-4-3, and decide which action items to implement to improve warehouse B's performance. For example, warehouse manager 110-2 may provide inventory accuracy awareness training to all staff members working at warehouse B. Warehouse manager 110-2 may decide not to conduct the recommended targeted 100% audit because of time/labor constraints.

After receiving recommended remedial plans, such as remedial action plan 180-4-3, warehouse manager 110-2 may provide feedback to inventory manager 110-1 using inventory management system 190 (step 440). For example, warehouse manager 110-2 may submit a new warehouse management requirement 180-3 to inventory management system 190. Warehouse manager 110-2 may also request the performance categories (red/yellow/green) for overall inventory accuracy be revised because of business reasons. Inventory manager 110-1 may incorporate the received feedback by making modifications to performance goals 180-2 and/or remedial action plans 180-4 accordingly.

Inventory management systems and methods consistent with the disclosed embodiments are not limited to the color coded type of designation for performance categories (red, yellow, green) and remedial plans. For example, the disclosed embodiments may also use performance categories and remedial plans corresponding to numerical values (e.g., level I, II, III, IV, etc.). The disclosed embodiments may use any type of format and content to represent performance categories and remedial action plans and the like.

### INDUSTRIAL APPLICABILITY

Inventory management systems and methods consistent with the disclosed embodiments improve warehouse performance. The disclosed embodiments enable a business manager, such as an inventory manager, to monitor and manage business organizations, such as warehouses, by measuring warehouse performance metrics against consistent performance goals and suggesting appropriate remedial action plans accordingly. The disclosed embodiments also enable an inventory manager to more proactively define performance goals for warehouses. The performance goals can be defined to measure inventory accuracy based on inventory quantity, inventory value, past warehouse performance, specific warehouse operations, statistical models, and the like. The performance goals can be defined to measure all aspects of warehouse performance, such as warehouse storage efficiency, equipment cost, labor cost, transportation cost, service quality, and the like.

The disclosed embodiments are applicable to managing inventory for many types of businesses and organizations. For example, a third party logistics provider may use the disclosed systems and methods to manage a network of warehouses. In particular, the third party logistic provider may define warehouse performance goals based on customer requirements. In addition to warehouses, businesses that perform other logistics activities such as transporting, shipping, and packaging may also benefit from improved inventory management processes consistent with the disclosed embodiments.

The disclosed embodiments can also be integrated into other performance measurement frameworks, such as the balanced score card, to provide performance metrics measuring a company's integration of marketing, production, purchasing, sales and logistics. For example, the balanced scorecard framework seeks to measure a company from the business process perspective by gathering performance metrics of business processes, such as performance metrics for logistics operations. The disclosed embodiments may be integrated into a balance score card framework to provide performance measurements for all types of business operations related to inventory management.

It will be apparent to those skilled in the art that various modifications and variations can be made in the disclosed embodiments without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. An inventory management system, comprising:
a memory that stores program code, and
a processor that executes the program code to perform an inventory management process including providing a remedial action plan in response to inventory management data, the inventory management process comprising:
receiving inventory management data indicating performance of a business organization measured according to an inventory management performance metric;
determining a performance category for the business organization based on the inventory management data, the performance category being associated with the inventory management performance metric and indicating a measurement range of the performance metric; and
providing a remedial action plan to the business organization in response to the determination of the performance category.

2. The system of claim 1, wherein the inventory management process further comprises:
receiving an inventory management requirement that reflects the inventory management performance metric.

3. The system of claim 1, wherein the inventory management process further comprises:
storing the remedial action plan, the remedial action plan including one or more remedial action items.

4. The system of claim 1, wherein the inventory management process further comprises:
notifying the business organization when its performance falls into the measurement range defined by the performance category.

5. The system of claim 2, wherein the inventory management process further comprises:
receiving feedback from the business organization.

6. The system of claim 5, wherein the inventory management process further comprises:
updating the performance category according to the received feedback.

7. The system of claim 5, wherein the performance category is defined based on the inventory management requirement, the inventory management data, and the feedback from the business organization.

8. The system of claim 5, wherein the business organization is a warehouse.

9. The system of claim 8, wherein the inventory management performance metric is defined based on inventory accuracy.

10. The system of claim 9, wherein the performance category is defined based on percentage of accountable inventory quantity.

11. A method for inventory management, comprising:
performing an inventory management process through an interaction of members of an inventory management environment, the inventory management process including:
receiving an inventory management requirement that reflects an inventory management performance metric,
receiving inventory management data indicating performance of a business organization measured according to the performance metric;
determining a performance category for the business organization based on the inventory management data, the performance category indicating a measurement range of the performance metric; and
providing a remedial action plan to the business organization in response to the determination of the performance category.

12. The method of claim 11, wherein the inventory management data includes inventory audit data used to estimate inventory accuracy.

13. The method of claim 12, wherein the process further includes:
storing the remedial action plan, the remedial action plan including one or more remedial action items.

14. The method of claim 12, wherein the process further includes:
receiving feedback from the business organization.

15. The method of claim 12, wherein the process further includes:
notifying the business organization when its performance falls into the measurement range defined by the performance category.

16. The system of claim 14, wherein the process further includes:
updating the performance category according to the received feedback.

17. The system of claim 16, wherein the performance category is defined based on the inventory management requirement, the inventory management data, and the feedback from the monitored business organization.

18. The system of claim 16, wherein the business organization is a warehouse.

19. The system of claim 18, wherein the inventory management performance metric is defined based on inventory accuracy.

20. The system of claim 19, wherein the performance category is defined based on percentage of accountable inventory quantity and average inventory value.
